(19) United States
(12) Patent Application Publication
(10) Pub. No.: US 2008/0004814 A1
(43) Pub. Date: Jan. 3, 2008

(54) Systems and methods for probe annotation

(76) Inventors: Charles F. Nelson, San Carlos, CO (US); Jing Gao, Santa Clara, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/478,973

(22) Filed: Jun. 29, 2006

(51) Int. Cl. G06F 19/00; G06F 17/30

(52) U.S. Cl. 702/20; 707/6

(57) ABSTRACT

Systems and methods for using the same to annotate biomolecular probes are provided. Also provided are computer program products for executing the subject methods.

### BACKGROUND

Biomolecular probes, such as nucleic acids and polypeptides, have become an increasingly important tool in the biotechnology industry and related fields. For a biomolecular probe to be of use in a particular binding assay, it needs to have associated with it specific information, e.g., its target binding specificity. This information is generally referred to as probe annotation.

One area in which annotated biomolecular probes are of particular use is in the generation and use of biopolymeric arrays. Biopolymeric arrays include regions of usually different sequence annotated probes arranged in a predetermined configuration on a substrate. These regions (sometimes referenced as “features”) are positioned at respective locations (“addresses”) on the substrate. The arrays, when exposed to a sample, will exhibit an observed binding pattern which can be detected upon interrogating the array. By correlating the observed binding pattern with the known locations of the annotated biopolymeric probes on the array, one can determine the presence and/or concentration of one or more probe-binding components of the sample.

### SUMMARY OF THE INVENTION

Systems and methods for using the same to annotate biomolecular probes using hybridization prediction are provided.

In certain embodiments, the invention provides a system for annotating a probe containing:
(A) a communication module containing an input manager for receiving input from a user and an output manager for communicating output to a user;
(B) a database containing annotated sequence information; and
(C) a processing module containing:
   (i) a probe annotation manager, wherein the probe annotation manager is configured to:
      (a) search the database to identify candidate targets for a probe, wherein the candidate targets have at least one region of similarity with a predetermined target sequence for the probe;
      (b) calculate at least one thermodynamic property of binding of the probe to each of the candidate target sequences; and
      (c) generate an annotation for the probe, wherein the annotation for the probe includes annotations of the candidate targets that are ranked based upon the calculated thermodynamic property.

In certain embodiments of the system, the database includes a public database.

In certain embodiments of the system, the public database is selected from: Ensembl, RefSeq, Tiger HGI, NCBI EST, NCBI Unigene, UCSC MRNA, and combinations thereof.

In certain embodiments of the system, the database includes a private database.

In certain embodiments, the system further includes a probe database.

In certain embodiments of the system, the probe database includes annotated probe sequences.

In certain embodiments of the system, the probe annotation manager is configured to store the generated probe annotation in the probe database.

In certain embodiments of the system, the probe annotation manager is configured to maintain any previous probe annotation(s) for the probe in the probe database.

In certain embodiments of the system, the probe annotation manager is configured to annotate probes in the probe sequence database at defined intervals.

In certain embodiments of the system, the probe annotation manager annotates probes in the probe database when prompted by a user.

In certain embodiments of the system, the probe annotation manager annotates a probe sequence submitted by a user.

In certain embodiments of the system, the at least one thermodynamic property is selected from: ΔG, ΔH and Tₘ.

In certain embodiments of the system, the probe annotation manager is further configured to return annotation information to a user for at least one probe based on a minimum threshold value for a thermodynamic property of probe/target binding entered by the user.

In certain embodiments of the system, the probe annotation manager is further configured to generate the predetermined target sequence.

In certain embodiments of the system, the predetermined target sequence is complimentary or substantially complementary to the probe sequence.

In certain embodiments of the system, the probe annotation manager is further configured to return annotation information to a user for at least one probe based on at least one hybridization condition.

In certain embodiments of the system, the at least one hybridization condition is selected from: buffer composition, buffer pH, temperature of hybridization, duration of hybridization, concentration of probe and/or target, type of label on a probe or target molecule, type of hybridization assay, and any combination thereof.

In certain embodiments, the invention provides a method of annotating a probe including:
(a) searching a database containing annotated sequences to identify candidate target sequences for a probe, wherein the candidate target sequences has at least one region of similarity with a predetermined target sequence for the probe;
(b) calculating at least one thermodynamic property of binding of the probe to each of the candidate target sequences; and
(c) generating an annotation for the probe, wherein the annotation for the probe contains annotations of the candidate targets that are ranked based upon the calculated thermodynamic property.

In certain embodiments, the at least one thermodynamic property is selected from: ΔG, ΔH and Tₘ.

In certain embodiments of the method, the database is a public database.

In certain embodiments of the method, the public database is selected from: Ensembl, RefSeq, Tiger HGI, NCBI EST, NCBI Unigene, UCSC MRNA, and combinations thereof.

In certain embodiments of the method, the database is a private database.

In certain embodiments of the method, the predetermined target sequence is complimentary or substantially complementary to the probe sequence.

In certain embodiments, the method further includes storing the generated at least one annotation for the probe in a probe database.

In certain embodiments of the method, the probe database comprises previous annotation(s) for the probe.

In certain embodiments, the invention provides a method of revising the results of a hybridization assay, the method comprising:
(a) updating the annotation of at least one probe employed in a hybridization assay according to a method of claim 18; and
(b) revising the results of the hybridization assay based on the updating.

In certain embodiments, the invention provides a computer program product comprising a computer readable storage medium having a computer program stored thereon, wherein the computer program, when loaded onto a computer, operates the computer to:
(a) search a database to identify candidate target sequences for a probe sequence, wherein the candidate target sequences comprise at least one region of similarity with a predetermined target sequence for the probe;
(b) calculate at least one thermodynamic property of binding of the probe to the optimal target sequence and each of the candidate target sequences; and
(c) generating an annotation for the probe, wherein the annotation for the probe comprises annotations of the candidate targets that are ranked based upon the calculated thermodynamic property.

### BRIEF DESCRIPTIONS OF THE DRAWINGS

FIG. 1 illustrates a substrate carrying multiple arrays, such as may be fabricated by methods of the present invention.

FIG. 2 is an enlarged view of a portion of FIG. 1 showing multiple ideal spots or features.

FIG. 3 is an enlarged illustration of a portion of the substrate in FIG. 2.

FIG. 4 illustrates how the annotations of candidate targets are associated and ranked with a particular biopolymeric probe using calculated thermodynamic properties of probe binding in the present invention.

FIG. 5 schematically illustrates an exemplary system of the present invention.

FIG. 6 provides a flow chart of an exemplary probe annotation method of the present invention.

### DEFINITIONS

Unless defined otherwise, all technical and scientific terms used herein have the same meaning as commonly understood by one of ordinary skill in the art to which this invention belongs. Still, certain elements are defined below for the sake of clarity and ease of reference.

By “array layout” is meant a collection of information, e.g., in the form of a file, which represents the location of probes that have been assigned to specific features of one or more array formats, e.g., a single array format or two or more array formats of an array set.

The phrase “array format” refers to a format that defines an array by feature number, feature size, Cartesian coordinates of each feature, and distance that exists between features within a given single array.

The phrase “array content information” is used to refer to any type of information/data that describes an array. Representative types of array content information include, but are not limited to: “probe-level information” and “array-level information”. By “probe-level information” is meant any information relating to the biochemical properties or descriptive characteristics of a probe. Examples include, but are not limited to: probe sequence, melting temperature (Tₘ), target gene or genes (e.g., gene name, accession number, etc.), location identifier information, information regarding cell(s) or tissue(s) in which a probe sequence is expressed and/or levels of expression, information concerning physiological responses of a cell or tissue in which the sequence is expressed (e.g., whether the cell or tissue is from a patient with a disease), chromosomal location information, copy number information, information relating to similar sequences (e.g., homologous, paralogous or orthologous sequences), frequency of the sequence in a population, information relating to polymorphic variants of the probe sequence (e.g., such as SNPs), information relating to splice variants (e.g., tissues, individuals in which such variants are expressed), demographic information relating to individual(s) in which the sequence is found, and/or other annotation information. By “array-level information” is meant information relating to the physical properties or intended use of an array. Examples include, but are not limited to: types of genes to be studied using the array, such as genes from a specific species (e.g., mouse, human), genes associated with specific tissues (e.g., liver, brain, cardiac), genes associated with specific physiological functions, (e.g., apoptosis, stress response), genes associated with disease states (e.g., cancer, cardiovascular disease), array format information, e.g., feature number, feature size, Cartesian coordinates of each feature, and distance that exists between features within a given array, etc.

A “data element” represents a property of a probe sequence, which can include the base composition of the probe sequence. Data elements can also include representations of other properties of probe sequences, such as expression levels in one or more tissues, interactions between a sequence (and/or its encoded products), and other molecules, a representation of copy number, a representation of the relationship between its activity (or lack thereof) in a cellular pathway (e.g., a signaling pathway) and a physiological response, sequence similarity to other probe sequences, a representation of its function, a representation of its modified, processed, and/or variant forms, a representation of splice variants, the locations of introns and exons, functional domains etc. A data element can be represented for example, by an alphanumeric string (e.g., representing bases), by a number, by “plus” and “minus” symbols or other symbols, by a color hue, by a word, or by another form (descriptive or nondescriptive) suitable for computation, analysis and/or processing for example, by a computer or other machine or system capable of data integration and analysis.

As used herein, the term “data structure” is intended to mean an organization of information, such as a physical or logical relationship among data elements, designed to support specific data manipulation functions, such as an algorithm. The term can include, for example, a list or other collection type of data elements that can be added, subtracted, combined or otherwise manipulated. Exemplarily, types of data structures include a list, linked-list, doubly linked-list, indexed list, table, matrix, queue, stack, heap, dictionary, flat file databases, relational databases, local databases, distributed databases, thin client databases and tree. The term also can include organizational structures of information that relate or correlate, for example, data elements from a plurality of data structures or other forms of data management structures. A specific example of information organized by a data structure of the invention is the association of a plurality of data elements relating to a gene, e.g., its sequence, expression level in one or more tissues, copy number, activity states (e.g., active or non-active in one or more tissues), its modified, processed and/or and/or variant forms, splice variants encoded by the gene, the locations of introns and exons, functional domains, interactions with other molecules, function, sequence similarity to other probe sequences, etc. A data structure can be a recorded form of information (such as a list) or can contain additional information (e.g., annotations) regarding the information contained therein. A data structure can include pointers or links to resources external to the data structure (e.g., such as external databases). In one aspect, a data structure is embodied in a tangible form, e.g. is stored or represented in a tangible medium (such as a computer readable medium).

The term “object” refers to a unique concrete instance of an abstract data type, a class (that is, a conceptual structure including both data and the methods to access it) whose identity is separate from that of other objects, although it can “communicate” with them via messages. In some occasions, some objects can be conceived of as a subprogram which can communicate with others by receiving or giving instructions based on its, or the others' data or methods. Data can consist of numbers, literal strings, variables, references, etc. In addition to data, an object can include methods for manipulating data. In certain instances, an object may be viewed as a region of storage. In the present invention, an object typically includes a plurality of data elements and methods for manipulating such data elements.

A “relation” or “relationship” is an interaction between multiple data elements and/or data structures and/or objects. A list of properties may be attached to a relation. Such properties may include name, type, location, etc. A relation may be expressed as a link in a network diagram. Each data element may play a specific “role” in a relation.

As used herein, an “annotation” is a comment, explanation, note, link, or metadata about a data element, data structure or object, or a collection thereof. Annotations may include pointers to external objects or external data. An annotation may optionally include information about an author who created or modified the annotation, as well as information about when that creation or modification occurred. In one embodiment, a memory comprising a plurality of data structures organized by annotation category provides a database through which information from multiple databases, public or private, may be accessed, assembled, and processed. Annotation tools include, but are not limited to, software such as BioFerret (available from Agilent Technologies, Inc., Palo Alto, Calif.), which is described in detail in application Ser. No. 10/033,823 filed Dec. 19, 2001 and titled “Domain-Specific Knowledge-Based Metasearch System and Methods of Using.” Such tools may be used to generate a list of associations between genes from scientific literature and patent publications.

As used herein an “annotation category” is a human readable string to annotate the logical type the object comprising its plurality of data elements represents. Data structures that contain the same types and instances of data elements may be assigned identical annotations, while data structures that contain different types and instances of data elements may be assigned different annotations.

As used herein, a “probe sequence identifier” or an “identifier corresponding to a probe sequence” refers to a string of one or more characters (e.g., alphanumeric characters), symbols, images or other graphical representation(s) associated with a probe sequence comprising a probe sequence such that the identifier provides a “shorthand” designation for the sequence. In one aspect, an identifier comprises an accession number or a clone number. An identifier may comprise descriptive information. For example, an identifier may include a reference citation or a portion thereof.

The phrase “best-fit” refers to a resource allocation scheme that determines the best result in response to input data. The definition of ‘best’ may vary depending on a given set of predetermined parameters, such as sequence identity limits, signal intensity limits, cross-hybridization limits, Tₘ, base composition limits, probe length limits, distribution of bases along the length of the probe, distribution of nucleation points along the length of the probe (e.g., regions of the probe likely to participate in hybridization, secondary structure parameters, etc. In one aspect, the system considers predefined thresholds. In another aspect, the system rank-orders fit. In a further aspect, the user defines his or her own thresholds, which may or may not include system-defined threshold.

The terms “system” and “computer-based system” refer to the hardware means, software means, and data storage means used to analyze the information of the present invention. The minimum hardware of the computer-based systems of the present invention comprises a central processing unit (CPU), input means, output means, and data storage means. As such, any convenient computer-based system may be employed in the present invention. The data storage means may comprise any manufacture comprising a recording of the present information as described above, or a memory access means that can access such a manufacture.

A “processor” references any hardware and/or software combination which will perform the functions required of it. For example, any processor herein may be a programmable digital microprocessor such as available in the form of an electronic controller, mainframe, server or personal computer (desktop or portable). Where the processor is programmable, suitable programming can be communicated from a remote location to the processor, or previously saved in a computer program product (such as a portable or fixed computer readable storage medium, whether magnetic, optical or solid state device based). For example, a magnetic medium or optical disk may carry the programming, and can be read by a suitable reader communicating with each processor at its corresponding station.

“Computer readable medium” as used herein refers to any storage or transmission medium that participates in providing instructions and/or data to a computer for execution and/or processing. Examples of storage media include floppy disks, magnetic tape, UBS, CD-ROM, a hard disk drive, a ROM or integrated circuit, a magneto-optical disk, or a computer readable card such as a PCMCIA card and the like, whether or not such devices are internal or external to the computer. A file containing information may be “stored” on computer readable medium, where “storing” means recording information such that it is accessible and retrievable at a later date by a computer. A file may be stored in permanent memory.

With respect to computer readable media, “permanent memory” refers to memory that is permanently stored on a data storage medium. Permanent memory is not erased by termination of the electrical supply to a computer or processor. Computer hard-drive ROM (i.e. ROM not used as virtual memory), CD-ROM, floppy disk and DVD are all examples of permanent memory. Random Access Memory (RAM) is an example of non-permanent memory. A file in permanent memory may be editable and re-writable.

To “record” data, programming or other information on a computer readable medium refers to a process for storing information, using any convenient method. Any convenient data storage structure may be chosen, based on the means used to access the stored information. A variety of data processor programs and formats can be used for storage, e.g. word processing text file, database format, etc.

A “memory” or “memory unit” refers to any device which can store information for subsequent retrieval by a processor, and may include magnetic or optical devices (such as a hard disk, floppy disk, CD, or DVD), or solid state memory devices (such as volatile or non-volatile RAM). A memory or memory unit may have more than one physical memory device of the same or different types (for example, a memory may have multiple memory devices such as multiple hard drives or multiple solid state memory devices or some combination of hard drives and solid state memory devices).

In certain embodiments, a system includes hardware components which take the form of one or more platforms, e.g., in the form of servers, such that any functional elements of the system, i.e., those elements of the system that carry out specific tasks (such as managing input and output of information, processing information, etc.) of the system may be carried out by the execution of software applications on and across the one or more computer platforms represented of the system. The one or more platforms present in the subject systems may be any convenient type of computer platform, e.g., such as a server, main-frame computer, a work station, etc. Where more than one platform is present, the platforms may be connected via any convenient type of connection, e.g., cabling or other communication system including wireless systems, either networked or otherwise. Where more than one platform is present, the platforms may be co-located or they may be physically separated. Various operating systems may be employed on any of the computer platforms, where representative operating systems include Windows, Sun Solaris, Linux, OS/400, Compaq Tru64 Unix, SGI IRIX, Siemens Reliant Unix, and others. The functional elements of system may also be implemented in accordance with a variety of software facilitators, platforms, or other convenient method.

Items of data are “linked” to one another in a memory when the same data input (for example, filename or directory name or search term) retrieves the linked items (in a same file or not) or an input of one or more of the linked items retrieves one or more of the others.

The term “monomer” as used herein refers to a chemical entity that can be covalently linked to one or more other such entities to form a polymer. Of particular interest to the present application are nucleotide “monomers” that have first and second sites (e.g., 5′ and 3′ sites) suitable for binding to other like monomers by means of standard chemical reactions (e.g., nucleophilic substitution), and a diverse element which distinguishes a particular monomer from a different monomer of the same type (e.g., a nucleotide base, etc.). In general, synthesis of nucleic acids of this type utilizes an initial substrate-bound monomer that is used as a building-block in a multi-step synthesis procedure to form a complete nucleic acid. A “biomonomer” references a single unit, which can be linked with the same or other biomonomers to form a biopolymer (e.g., a single amino acid or nucleotide with two linking groups, one or both of which may have removable protecting groups).

The terms “nucleoside” and “nucleotide” are intended to include those moieties which contain not only the known purine and pyrimidine bases, but also other heterocyclic bases that have been modified. Such modifications include methylated purines or pyrimidines, acylated purines or pyrimidines, alkylated riboses or other heterocycles. In addition, the terms “nucleoside” and “nucleotide” include those moieties that contain not only conventional ribose and deoxyribose sugars, but other sugars as well. Modified nucleosides or nucleotides also include modifications on the sugar moiety, e.g., wherein one or more of the hydroxyl groups are replaced with halogen atoms or aliphatic groups, or are functionalized as ethers, amines, or the like.

As used herein, the term “amino acid” is intended to include not only the L, D- and nonchiral forms of naturally occurring amino acids (alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, valine), but also modified amino acids, amino acid analogs, and other chemical compounds which can be incorporated in conventional oligopeptide synthesis, e.g., 4-nitrophenylalanine, isoglutamic acid, isoglutamine, ε-nicotinoyl-lysine, isonipecotic acid, tetrahydroisoquinoleic acid, α-aminoisobutyric acid, sarcosine, citrulline, cysteic acid, t-butylglycine, t-butylalanine, phenylglycine, cyclohexylalanine, β-alanine, 4-aminobutyric acid, and the like.

The term “oligomer” is used herein to indicate a chemical entity that contains a plurality of monomers. As used herein, the terms “oligomer” and “polymer” are used interchangeably, as it is generally, although not necessarily, smaller “polymers” that are prepared using the functionalized substrates of the invention, particularly in conjunction with combinatorial chemistry techniques. Examples of oligomers and polymers include polydeoxyribonucleotides (DNA), polyribonucleotides (RNA), other polynucleotides which are C-glycosides of a purine or pyrimidine base, polypeptides (proteins), polysaccharides (starches, or polysugars), and other chemical entities that contain repeating units of like chemical structure. In the practice of the instant invention, oligomers will generally comprise about 2-50 monomers, preferably about 2-20, more preferably about 3-10 monomers.

The term “polymer” means any compound that is made up of two or more monomeric units covalently bonded to each other, where the monomeric units may be the same or different, such that the polymer may be a homopolymer or a heteropolymer. Representative polymers include peptides, polysaccharides, nucleic acids and the like, where the polymers may be naturally occurring or synthetic.

A “biopolymer” is a polymer of one or more types of repeating units. Biopolymers are typically found in biological systems (although they may be made synthetically) and may include peptides or polynucleotides, as well as such compounds composed of or containing amino acid analogs or non-amino acid groups, or nucleotide analogs or non-nucleotide groups. This includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions. Polynucleotides include single or multiple stranded configurations, where one or more of the strands may or may not be completely aligned with another. For example, a “biopolymer” may include DNA (including cDNA), RNA, oligonucleotides, and PNA and other polynucleotides as described in U.S. Pat. No. 5,948,902 and references cited therein (all of which are incorporated herein by reference), regardless of the source.

The term “biomolecular probe” or “probe” means any organic or biochemical molecule, group or species of interest having a particular sequence or structure. In certain embodiments, a biomolecular probe may be formed in an array on a substrate surface. Exemplary biomolecular probes include polypeptides, proteins, oligonucleotide and polynucleotides.

The term “ligand” as used herein refers to a moiety that is capable of covalently or otherwise chemically binding a compound of interest. The arrays of solid-supported ligands produced by the methods can be used in screening or separation processes, or the like, to bind a component of interest in a sample. The term “ligand” in the context of the invention may or may not be an “oligomer” as defined above. However, the term “ligand” as used herein may also refer to a compound that is “pre-synthesized” or obtained commercially, and then attached to the substrate.

The term “sample” as used herein relates to a material or mixture of materials, typically, although not necessarily, in fluid form, containing one or more components of interest.

A biomonomer fluid or biopolymer fluid refers to a liquid containing either a biomonomer or biopolymer, respectively (typically in solution).

The term “peptide” as used herein refers to any polymer compound produced by amide formation between an a-carboxyl group of one amino acid and an α-amino group of another group.

The term “oligopeptide” as used herein refers to peptides with fewer than about 10 to 20 residues, i.e., amino acid monomeric units.

The term “polypeptide” as used herein refers to peptides with more than 10 to 20 residues.

The term “protein” as used herein refers to polypeptides of specific sequence of more than about 50 residues.

The term “nucleic acid” as used herein means a polymer composed of nucleotides, e.g., deoxyribonucleotides or ribonucleotides, or compounds produced synthetically (e.g., PNA as described in U.S. Pat. No. 5,948,902 and the references cited therein) which can hybridize with naturally occurring nucleic acids in a sequence specific manner analogous to that of two naturally occurring nucleic acids, e.g., can participate in Watson-Crick base pairing interactions.

The terms “ribonucleic acid” and “RNA” as used herein mean a polymer composed of ribonucleotides.

The terms “deoxyribonucleic acid” and “DNA” as used herein mean a polymer composed of deoxyribonucleotides.

The term “oligonucleotide” as used herein denotes single-stranded nucleotide multimers of from about 10 up to about 200 nucleotides in length, e.g., from about 25 to about 200 nt, including from about 50 to about 175 nt, e.g. 150 nt in length

The term “polynucleotide” as used herein refers to single- or double-stranded polymers composed of nucleotide monomers of generally greater than about 100 nucleotides in length.

An “array,” or “chemical array” used interchangeably includes any one-dimensional, two-dimensional or substantially two-dimensional (as well as a three-dimensional) arrangement of addressable regions bearing a particular chemical moiety or moieties (such as ligands, e.g., biopolymers such as polynucleotide or oligonucleotide sequences (nucleic acids), polypeptides (e.g., proteins), carbohydrates, lipids, etc.) associated with that region. As such, an addressable array includes any one or two or even three-dimensional arrangement of discrete regions (or “features”) bearing particular biopolymer moieties (for example, different polynucleotide sequences) associated with that region and positioned at particular predetermined locations on the substrate (each such location being an “address”). These regions may or may not be separated by intervening spaces. In the broadest sense, the arrays of many embodiments are arrays of polymeric binding agents, where the polymeric binding agents may be any of: polypeptides, proteins, nucleic acids, polysaccharides, synthetic mimetics of such biopolymeric binding agents, etc. In many embodiments of interest, the arrays are arrays of nucleic acids, including oligonucleotides, polynucleotides, cDNAs, mRNAs, synthetic mimetics thereof, and the like. Where the arrays are arrays of nucleic acids, the nucleic acids may be covalently attached to the arrays at any point along the nucleic acid chain, but are generally attached at one of their termini (e.g. the 3′ or 5′ terminus). Sometimes, the arrays are arrays of polypeptides, e.g., proteins or fragments thereof.

Any given substrate may carry one, two, four or more or more arrays disposed on a front surface of the substrate. Depending upon the use, any or all of the arrays may be the same or different from one another and each may contain multiple spots or features. A typical array may contain more than ten, more than one hundred, more than one thousand more ten thousand features, or even more than one hundred thousand features, in an area of less than 20 cm² or even less than 10 cm². For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges. At least some, or all, of the features are of different compositions (for example, when any repeats of each feature composition are excluded the remaining features may account for at least 5%, 10%, or 20% of the total number of features). Interfeature areas will typically (but not essentially) be present which do not carry any polynucleotide (or other biopolymer or chemical moiety of a type of which the features are composed). Such interfeature areas typically will be present where the arrays are formed by processes involving drop deposition of reagents but may not be present when, for example, light directed synthesis fabrication processes are used. It will be appreciated though, that the interfeature areas, when present, could be of various sizes and configurations.

Each array may cover an area of less than 100 cm², or even less than 50 cm², 10 cm² or 1 cm². In many embodiments, the substrate carrying the one or more arrays will be shaped generally as a rectangular solid (although other shapes are possible), having a length of more than 4 mm and less than 1 m, usually more than 4 mm and less than 600 mm, more usually less than 400 mm; a width of more than 4 mm and less than 1 m, usually less than 500 mm and more usually less than 400 mm; and a thickness of more than 0.01 mm and less than 5.0 mm, usually more than 0.1 mm and less than 2 mm and more usually more than 0.2 and less than 1 mm. With arrays that are read by detecting fluorescence, the substrate may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, substrate 10 may transmit at least 20%, or 50% (or even at least 70%, 90%, or 95%), of the illuminating light incident on the front as may be measured across the entire integrated spectrum of such illuminating light or alternatively at 532 nm or 633 nm.

Arrays may be fabricated using drop deposition from pulse jets of either precursor units (such as nucleotide or amino acid monomers) in the case of in situ fabrication, or the previously obtained biomolecule, e.g., polynucleotide. Such methods are described in detail in, for example, the previously cited references including U.S. Pat. No. 6,242,266, U.S. Pat. No. 6,232,072, U.S. Pat. No. 6,180,351, U.S. Pat. No. 6,171,797, U.S. Pat. No. 6,323,043, U.S. patent application Ser. No. 09/302,898 filed Apr. 30, 1999 by Caren et al., and the references cited therein. Other drop deposition methods can be used for fabrication, as previously described herein.

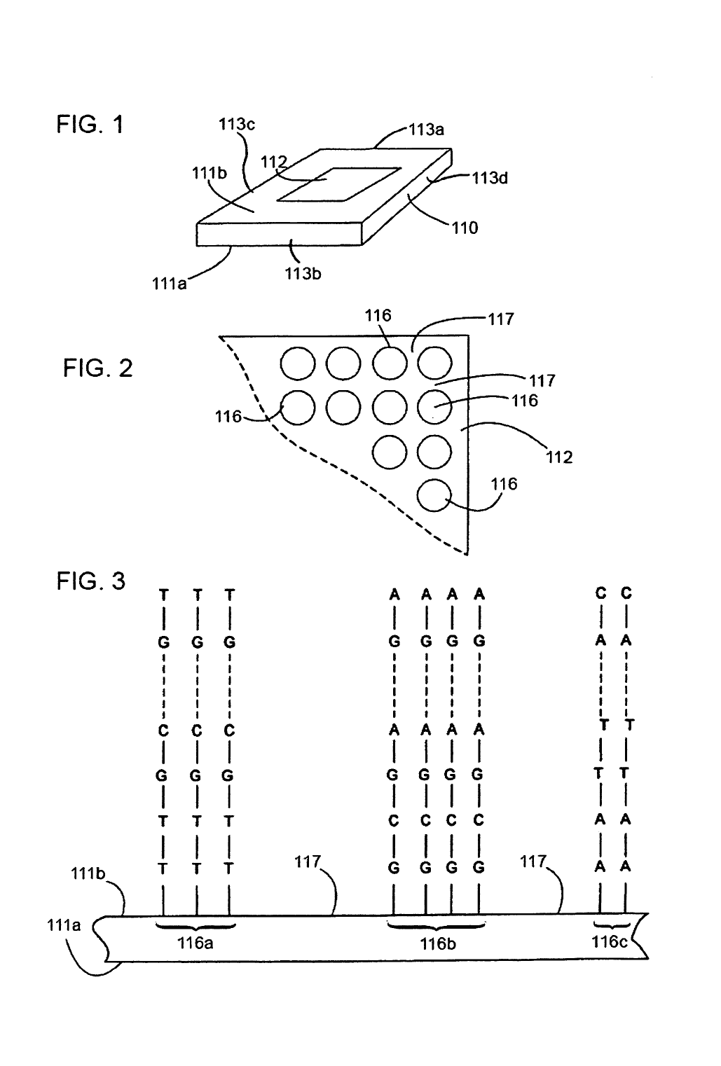

An exemplary chemical array is shown in FIGS. 1-3, where the array shown in this representative embodiment includes a contiguous planar substrate 110 carrying an array 112 disposed on a surface 111b of substrate 110. It will be appreciated though, that more than one array (any of which are the same or different) may be present on surface 111b, with or without spacing between such arrays. That is, any given substrate may carry one, two, four or more arrays disposed on a front surface of the substrate and depending on the use of the array, any or all of the arrays may be the same or different from one another and each may contain multiple spots or features. The one or more arrays 112 usually cover only a portion of the surface 111b, with regions of the rear surface 111b adjacent the opposed sides 113c, 113d and leading end 113a and trailing end 113b of slide 110, not being covered by any array 112. A second surface 111a of the slide 110 does not carry any arrays 112. Each array 112 can be designed for testing against any type of sample, whether a trial sample, reference sample, a combination of them, or a known mixture of biopolymers such as polynucleotides. Substrate 110 may be of any shape, as mentioned above.

As mentioned above, array 112 contains multiple spots or features 116 of biopolymer ligands, e.g., in the form of polynucleotides. As mentioned above, all of the features 116 may be different, or some or all could be the same. The interfeature areas 117 could be of various sizes and configurations. Each feature carries a predetermined biopolymer such as a predetermined polynucleotide (which includes the possibility of mixtures of polynucleotides). It will be understood that there may be a linker molecule (not shown) between the rear surface 111b and the first nucleotide. Any convenient linker may be used.

Substrate 110 may carry on surface 111a, an identification code, e.g., in the form of bar code (not shown) or the like printed on a substrate in the form of a paper label attached by adhesive or any convenient means. The identification code contains information relating to array 112, where such information may include, but is not limited to, an identification of array 112, i.e., layout information relating to the array(s), etc.

The substrate may be porous or non-porous. The substrate may have a planar or non-planar surface.

In those embodiments where an array includes two more features immobilized on the same surface of a solid support, the array may be referred to as addressable. An array is “addressable” when it has multiple regions of different moieties (e.g., different polynucleotide sequences) such that a region (i.e., a “feature” or “spot” of the array) at a particular predetermined location (i.e., an “address”) on the array will detect a particular target or class of targets (although a feature may incidentally detect non-targets of that feature). Array features are typically, but need not be, separated by intervening spaces. In the case of an array, the “target” will be referenced as a moiety in a mobile phase (typically fluid), to be detected by probes (“target probes”) which are bound to the substrate at the various regions. However, either of the “target” or “probe” may be the one which is to be evaluated by the other (thus, either one could be an unknown mixture of analytes, e.g., polynucleotides, to be evaluated by binding with the other).

An array “assembly” includes a substrate and at least one chemical array, e.g., on a surface thereof. Array assemblies may include one or more chemical arrays present on a surface of a device that includes a pedestal supporting a plurality of prongs, e.g., one or more chemical arrays present on a surface of one or more prongs of such a device. An assembly may include other features (such as a housing with a chamber from which the substrate sections can be removed). “Array unit” may be used interchangeably with “array assembly”.

The term “substrate” as used herein refers to a surface upon which marker molecules or probes, e.g., an array, may be adhered. Glass slides are the most common substrate for biochips, although fused silica, silicon, plastic and other materials are also suitable.

When two items are “associated” with one another they are provided in such a way that it is apparent one is related to the other such as where one references the other. For example, an array identifier can be associated with an array by being on the array assembly (such as on the substrate or a housing) that carries the array or on or in a package or kit carrying the array assembly. “Stably attached” or “stably associated with” means an item's position remains substantially constant where in certain embodiments it may mean that an item's position remains substantially constant and known.

A “web” references a long continuous piece of substrate material having a length greater than a width. For example, the web length to width ratio may be at least 5/1, 10/1, 50/1, 100/1, 200/1, or 500/1, or even at least 1000/1.

“Flexible” with reference to a substrate or substrate web, refers to a substrate that can be bent 180 degrees around a roller of less than 1.25 cm in radius. The substrate can be so bent and straightened repeatedly in either direction at least 100 times without failure (for example, cracking) or plastic deformation. This bending must be within the elastic limits of the material. The foregoing test for flexibility is performed at a temperature of 20° C.

“Rigid” refers to a material or structure which is not flexible, and is constructed such that a segment about 2.5 by 7.5 cm retains its shape and cannot be bent along any direction more than 60 degrees (and often not more than 40, 20, 10, or 5 degrees) without breaking.

The terms “hybridizing specifically to” and “specific hybridization” and “selectively hybridize to,” as used herein refer to the binding, duplexing, or hybridizing of a nucleic acid molecule preferentially to a particular nucleotide sequence under stringent conditions.

“Hybridizing” and “binding”, with respect to polynucleotides, are used interchangeably.

The term “stringent assay conditions” as used herein refers to conditions that are compatible to produce binding pairs of nucleic acids, e.g., surface bound and solution phase nucleic acids, of sufficient complementarity to provide for the desired level of specificity in the assay while being less compatible to the formation of binding pairs between binding members of insufficient complementarity to provide for the desired specificity. Stringent assay conditions are the summation or combination (totality) of both hybridization and wash conditions.

“Stringent hybridization conditions” and “stringent hybridization wash conditions” in the context of nucleic acid hybridization (e.g., as in array, Southern or Northern hybridizations) are sequence dependent, and are different under different experimental parameters. Stringent hybridization conditions that can be used to identify nucleic acids within the scope of the invention can include, e.g., hybridization in a buffer comprising 50% formamide, 5×SSC, and 1% SDS at 42° C., or hybridization in a buffer comprising 5×SSC and 1% SDS at 65° C., both with a wash of 0.2×SSC and 0.1% SDS at 65° C. Exemplary stringent hybridization conditions can also include a hybridization in a buffer of 40% formamide, 1 M NaCl, and 1% SDS at 37° C., and a wash in 1×SSC at 45° C. Alternatively, hybridization to filter-bound DNA in 0.5 M NaHPO₄, 7% sodium dodecyl sulfate (SDS), 1 mM EDTA at 65° C., and washing in 0.1×SSC/0.1% SDS at 68° C. can be employed. Yet additional stringent hybridization conditions include hybridization at 60° C. or higher and 3×SSC (450 mM sodium chloride/45 mM sodium citrate) or incubation at 42° C. in a solution containing 30% formamide, 1M NaCl, 0.5% sodium sarcosine, 50 mM MES, pH 6.5. Those of ordinary skill will readily recognize that alternative but comparable hybridization and wash conditions can be utilized to provide conditions of similar stringency.

In certain embodiments, the stringency of the wash conditions sets forth the conditions which determine whether a nucleic acid is specifically hybridized to a surface bound nucleic acid. Wash conditions used to identify nucleic acids may include, e.g.: a salt concentration of about 0.02 molar at pH 7 and a temperature of at least about 50° C. or about 55° C. to about 60° C.; or, a salt concentration of about 0.15 M NaCl at 72° C. for about 15 minutes; or, a salt concentration of about 0.2×SSC at a temperature of at least about 50° C. or about 55° C. to about 60° C. for about 15 to about 20 minutes; or, the hybridization complex is Washed twice with a solution with a salt concentration of about 2×SSC containing 0.1% SDS at room temperature for 15 minutes and then washed twice by 0.1×SSC containing 0.1% SDS at 68° C. for 15 minutes; or, equivalent conditions. Stringent conditions for washing can also be, e.g., 0.2×SSC/0.1% SDS at 42° C.

A specific example of stringent assay conditions is rotating hybridization at 65° C. in a salt based hybridization buffer with a total monovalent cation concentration of 1.5 M (e.g., as described in U.S. patent application Ser. No. 09/655,482 filed on Sep. 5, 2000, the disclosure of which is herein incorporated by reference) followed by washes of 0.5×SSC and 0.1×SSC at room temperature.

Stringent assay conditions are hybridization conditions that are at least as stringent as the above representative conditions, where a given set of conditions are considered to be at least as stringent if substantially no additional binding complexes that lack sufficient complementarity to provide for the desired specificity are produced in the given set of conditions as compared to the above specific conditions, where by “substantially no more” is meant less than about 5-fold more, typically less than about 3-fold more. Other stringent hybridization conditions may also be employed, as appropriate.

“Contacting” means to bring or put together. As such, a first item is contacted with a second item when the two items are brought or put together, e.g., by touching them to each other.

“Depositing” means to position, place an item at a location—or otherwise cause an item to be so positioned or placed at a location. Depositing includes contacting one item with another. Depositing may be manual or automatic, e.g., “depositing” an item at a location may be accomplished by automated robotic devices.

By “remote location,” it is meant a location other than the location at which the array (or referenced item) is present and hybridization occurs (in the case of hybridization reactions). For example, a remote location could be another location (e.g., office, lab, etc.) in the same city, another location in a different city, another location in a different state, another location in a different country, etc. As such, when one item is indicated as being “remote” from another, what is meant is that the two items are at least in different rooms or different buildings, and may be at least one mile, ten miles, or at least one hundred miles apart.

“Communicating” information means transmitting the data representing that information as signals (e.g., electrical, optical, radio signals, and the like) over a suitable communication channel (for example, a private or public network).

“Forwarding” an item refers to any means of getting that item from one location to the next, whether by physically transporting that item or otherwise (where that is possible) and includes, at least in the case of data, physically transporting a medium carrying the data or communicating the data.

An array “package” may be the array plus only a substrate on which the array is deposited, although the package may include other features (such as a housing with a chamber).

A “chamber” references an enclosed volume (although a chamber may be accessible through one or more ports). It will also be appreciated that throughout the present application, that words such as “top,” “upper,” and “lower” are used in a relative sense only.

It will also be appreciated that throughout the present application, that words such as “cover”, “base” “front”, “back”, “top”, are used in a relative sense only. The word “above” used to describe the substrate and/or flow cell is meant with respect to the horizontal plane of the environment, e.g., the room, in which the substrate and/or flow cell is present, e.g., the ground or floor of such a room.

“Optional” or “optionally” means that the subsequently described circumstance may or may not occur, so that the description includes instances where the circumstance occurs and instances where it does not. For example, the phrase “optionally substituted” means that a non-hydrogen substituent may or may not be present, and, thus, the description includes structures wherein a non-hydrogen substituent is present and structures wherein a non-hydrogen substituent is not present.

### DETAILED DESCRIPTION

Systems and methods for annotating biomolecular probes are provided. The subject systems include a database having annotated biomolecular sequences, a communications module, and a processing module, where the processing module includes a probe annotation manager configured to search the database for candidate targets for a probe, calculate a thermodynamic property of binding of the probe to the candidate target, and annotate the probe based on annotation of the candidate target(s) and the calculated thermodynamic property. In certain embodiments, the system contains a probe database in which biomolecular probe sequences and their annotations are stored. Also provided are computer program products for executing the subject methods.

Before the present invention is described in greater detail, it is to be understood that this invention is not limited to particular embodiments described, as such may vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now-described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

In the event that one or more of the incorporated literature and similar materials differs from or contradicts this application, including but not limited to defined terms, term usage, described techniques, or the like, this application controls.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

Aspects of the invention include systems and methods for annotating a probe based on target binding prediction. Representative embodiments of the subject systems generally include the following components: (a) a database of annotated target sequences; (b) a communications module for facilitating information transfer between the system and one or more users, e.g., via a user computer, as described below; and (c) a processing module for performing one or more tasks involved in the probe annotation methods of the invention. In representative embodiments, the subject systems may be viewed as being the physical embodiment of a web portal, where the term “web portal” refers to a web site or service, e.g., as may be viewed in the form of a web page, that offers a broad array of resources and services to users via an electronic communication element, e.g., via the Internet.

In certain embodiments, the subject systems are components of array development systems, including but not limited to those systems described in Published United States Application publication Nos. 20060116827; 20060116825 and 20060115822, as well as U.S. application Ser. Nos. 11/349,425 and 11/349,398; the disclosures of which are herein incorporated by reference.

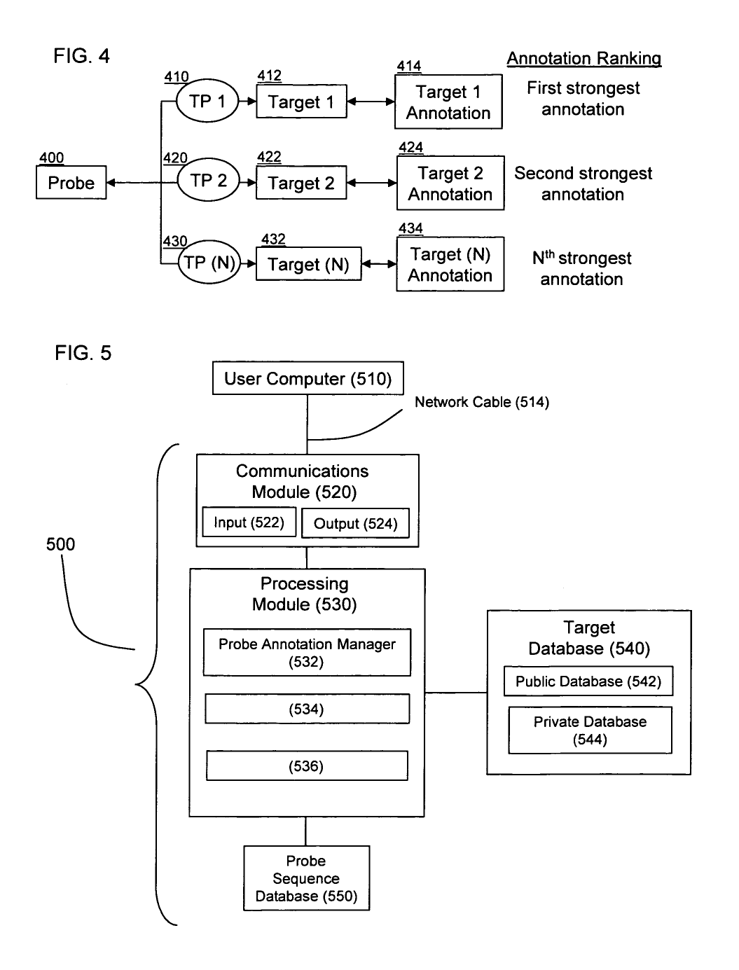

FIG. 4 illustrates how the annotations of candidate targets are associated and ranked with a particular biopolymeric probe using calculated thermodynamic properties in the present invention. In this figure, a specific biopolymeric probe 400 and candidate targets (412, 422 and 432, having annotations 414, 424 and 434 respectively) have been identified and a thermodynamic property (TP) of binding of the probe to each of these candidate targets has been calculated (410, 420 and 430). In certain embodiments, each of the calculated thermodynamic properties is calculated based upon a standard probe/target binding condition. For example, in embodiments in which the probe and candidate targets are nucleic acids, the thermodynamic property of binding may be calculated based upon binding occurring under stringent hybridization conditions, as defined above. As is illustrated in this figure, annotations for each target are associated with the probe and ranked based upon the calculated thermodynamic property. Specifically, Target 1 (412) is ranked as the first strongest binding target for the probe 400 based upon its calculated thermodynamic property and thus its annotation is ranked as the first strongest annotation. Target 2 (422) is ranked as the second strongest binding target for the probe 400 based upon its calculated thermodynamic property, and thus its annotation is ranked as the second strongest annotation for the probe. Ranking of each target in this way allows one to evaluate the “tightness” with which a target annotation is associated with a given probe. The association and ranking of annotations based on calculated thermodynamic properties of binding (also called binding characteristics) provides for advantages over current annotation methodologies, as described in more detail below.

FIG. 5 provides a view of a representative probe annotation system according to an embodiment of the subject invention. In FIG. 5, system 500 includes communications module 520 and processing module 530, where each module may be present on the same or different platforms, e.g., servers, as described above.

The communications module includes the input manager 522 and output manager 524 functional elements. Input manager 522 receives information from a user e.g., over the Internet. Input manager 522 processes and forwards this information to the processing module 530. These functions are implemented using any convenient method or technique. Another of the functional elements of communications module 520 is output manager 524. Output manager 524 provides information assembled by processing module 530 to a user, e.g., over the Internet. The presentation of data by the output manager may be implemented in accordance with any convenient methods or techniques. As some examples, data may include SQL, HTML or XML documents, email or other files, or data in other forms. The data may include Internet URL addresses so that a user may retrieve additional SQL, HTML, XML, or other documents or data from remote sources.

The communications module 520 may be operatively connected to a user computer 510, which provides a vehicle for a user to interact with the system 500. User computer 510, shown in FIG. 5, may be a computing device specially designed and configured to support and execute any of a multitude of different applications. Computer 510 also may be any of a variety of types of general-purpose computers such as a personal computer, network server, workstation, or other computer platform now or later developed. Computer 510 may include components such as a processor, an operating system, a graphical user interface (GUI) controller, a system memory, memory storage devices, and input-output controllers. There are many possible configurations of the components of computer 510 and some components are not listed above, such as cache memory, a data backup unit, and many other devices.

In certain embodiments, a computer program product is described comprising a computer usable medium having control logic (computer software program, including program code) stored therein. The control logic, when executed by the processor the computer, causes the processor to perform functions described herein. In other embodiments, some functions are implemented primarily in hardware using, for example, a hardware state machine. Implementation of the hardware state machine so as to perform the functions described herein may be accomplished using any convenient method and techniques.

In certain embodiments, a user employs the user computer to enter information into and retrieve information from the system. As shown in FIG. 5, computer 510 is coupled via network cable 514 to the system 500. Additional computers of other users and/or administrators of the system in a local or wide-area network including an Intranet, the Internet, or any other network may also be coupled to system 500 via cable 514. It will be understood that cable 514 is merely representative of any type of network connectivity, which may involve cables, transmitters, relay stations, network servers, wireless communication devices, and many other components not shown suitable for the purpose. Via user computer 510, a user may operate a web browser served by a user-side Internet client to communicate via Internet with system 500. System 500 may similarly be in communication over Internet with other users, networks of users, and/or system administrators, as desired.

As reviewed above, the systems include various functional elements that carry out specific tasks on the platforms in response to information introduced into the system by one or more users. In FIG. 5, elements 532, 534 and 536 represent three different functional elements of processing module 530. While three different functional elements are shown, it is noted that the number of functional elements may be more or less, depending on the particular embodiment of the invention. Representative functional elements that may be carried out by the processing module are now reviewed in greater detail below.

In certain embodiments, the subject system includes annotated target database 540 and probe annotation manager 532 as part of the processing module 530, which is configured to perform functions relating to annotating a biopolymeric probe based on target annotations in the annotated target database 540. As described in detail below, in certain embodiments, the probe annotation manager is configured to annotate a probe entered into the system, e.g., a probe entered by a user of the system. In certain of these embodiments, the probe is annotated at the request of a user whereas in certain other embodiments, the probe is annotated automatically by the system, e.g., at regularly scheduled time interval.

In certain embodiments, the probe annotation manager is configured to approve a user to access the system 500. For example, the probe annotation manager may require a user to provide certain qualifying information before accessing the system. The type of qualifying information can be virtually any user-specific information that the administrator and/or operator of the system deems necessary for gaining access to the system. For example, in certain embodiments qualifying information includes one or more of the following: name, email address, contact information (e.g., work telephone number), affiliation, job title, mailing address, etc. If a user of the system has a prior relationship with the operator of the system (e.g., a user is a customer of the operator), the user-specific information may be in the form of a user-specific ID that has been previously assigned to the user (e.g., a customer number). In certain embodiments, the system may provide different levels of access to system components which require different types of qualifying information.

In certain embodiments, the system 500 of the invention contains an array layout developer (e.g., element 534) as a component of the processing module 530 which is configured to develop an array layout for a user. By “array layout” is meant a collection of information, e.g., in the form of a file, that represents the location of probes that have been assigned to specific features of an array format or formats. The phrase “array format” refers to a format that defines an array by feature number, feature size, Cartesian coordinates of each feature, and distance that exists between features within a given array. An exemplary embodiment of an array layout developer is disclosed in U.S. patent application Ser. No. 11/349,452, filed on Feb. 6, 2006, which is incorporated herein by reference in its entirety.

In certain embodiments, annotated target database 540 contains one or more public target databases (542) (e.g., Ensembl, RefSeq, Tiger HGI, NCBI EST, NCBI Unigene, and/or UCSC MRNA). In certain embodiments, annotated target database 540 contains one or more private databases that contain annotated targets (544) (e.g., databases maintained and administered by private entities).

In certain embodiments, the system of the invention includes a probe database 550 that contains biopolymeric probes that are annotated or will be annotated using system 500. The probe database may contain any number of types of information associated with a probe. Such probe-associated information includes current or previous annotations, calculated thermodynamic properties of binding of a probe to a candidate target, information regarding the source of the probe (e.g., the user who submitted it to the system), and/or alignments of a predetermined, e.g., optimal, probe target with one or more candidate probe targets (e.g., a BLAST nucleic acid alignment). In certain embodiments the probe database 550 contains biopolymeric probe data that can be accessed by any user of the system, whereas in other embodiments, the probe database 550 contains biopolymeric probe data that can be accessed only by a subset of users of the system. For example, a probe stored in the probe database may only be accessible to the user who submitted it to the system.

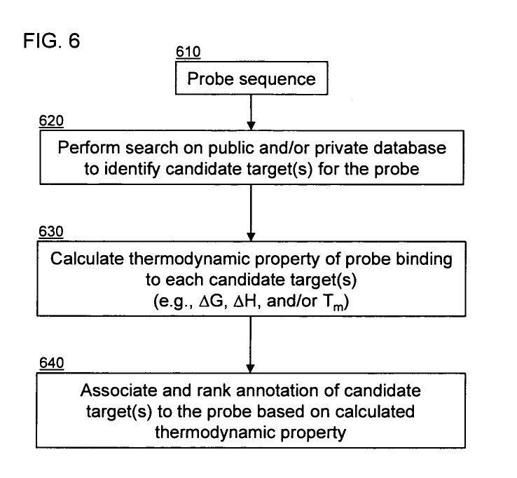

A flow diagram implementing certain aspects of the probe annotation manager of the invention is provided in FIG. 6. A system of the invention may include additional aspects and/or exclude certain aspects shown in FIG. 6 (and discussed below).

At step 610, a probe sequence is obtained by the system (e.g., a probe submission by a user, a probe designed by probe design software, or any other convenient method). In certain embodiments, the obtained (or submitted) probe has an annotation(s) already associated with it. For example, a user of the system may submit an annotated probe to the system to check the accuracy/relevance of the annotation and/or to update the annotation for that probe.

At step 620, the system queries the target database to identify candidate targets for that probe using any convenient method. By “candidate target” is meant a target that contains one or more regions that are predicted to bind to the probe. In certain embodiments, the predicted probe-binding region(s) of a target are regions that have similarity to a known probe-binding moiety (e.g., an amino acid sequence, a nucleic acid sequence, or a specific carbohydrate). For example, if the probe is a monoclonal antibody having a known binding specificity (e.g., a known sequence of amino acids to which it binds), a candidate target would be a protein/polypeptide that contains one or more amino acid sequences that are the same or substantially the same as the known amino acid sequence to which it binds. For nucleic acid probes, a candidate target contains one or more regions, e.g., ranging in length from about 2 to about 1000, such as from about 5 to about 500, including from about 15 to about 250 nt, that are the same or substantially the same as a sequence that is complimentary to the probe. In certain embodiments, substantially the same means a sequence that shares about 80% or more, such as about 85% or more and including about 90% or more, e.g., about 95% or more, sequence identity with a sequence that is complimentary to the probe. For example, complementary sequences of the DNA sequence 5′ A-T-G-C 3′ include the DNA sequence 5′ G-C-A-T 3′ as well as the RNA sequence 5′ G-C-A-U 3′, where 5′ and 3′ indicate the directionality of the nucleic acid strands, as is commonly used in the art. As indicated above, the target database can contain any number of public and/or private databases that contain annotated targets.

At step 630, the probe annotation manger calculates a thermodynamic property of probe binding to the candidate target(s) returned from the query of the target database using any convenient method. By “thermodynamic property of probe binding” is meant any thermodynamic property that pertains to the tightness or strength of binding between a probe and a target. Non-limiting examples of such thermodynamic properties include ΔG, melting temperature (Tₘ), and ΔH. The thermodynamic property may be calculated using any convenient method. In certain embodiments, the thermodynamic property is calculated by assuming specific probe/candidate target binding conditions. For example, calculating a thermodynamic property of binding between a nucleic acid probe and a nucleic acid target can be done by assuming that the binding is done under stringent hybridization conditions (such hybridization conditions are described in detail, above). In certain embodiments, a thermodynamic property of binding of the probe to a predetermined, e.g., an optimal, target is also calculated. By predetermined is meant an already identified or chosen target sequence: By “optimal target” is meant a target that is known or designed to bind tightly to the probe of interest. For example, an optimal target for a nucleic acid probe having a specific sequence is its exact complementary sequence, as described above. In certain embodiments, the optimal target is provided by the user, whereas in other embodiments, the optimal target for a probe is generated or identified by the system.

At step 640, the probe annotation manager associates and ranks at least one annotation of a candidate target to the probe based on the calculated thermodynamic property (e.g., as illustrated in FIG. 4). In certain embodiments, only annotations for targets that have calculated thermodynamic properties of probe binding over a certain threshold will be associated with the probe. The threshold can be determined by a user and/or administrator of the system. In certain embodiments, the threshold level is set to reflect stringent hybridization conditions.

In certain embodiments, the probe annotation manager stores the associated and ranked annotation(s) in the probe database as well as the calculated thermodynamic property. In certain embodiments, the probe annotation manager stores additional probe-associated information in the database. For example, in certain embodiments, the probe annotation manager stores alignment scores of an optimal probe target with each candidate target (e.g., a BLAST alignment score). In certain embodiments, the probe annotation manager stores any previous annotations of a probe in a probe annotation history. For example, one can employ the system/method of the invention to update the annotation of an already annotated probe. Once the annotation is updated, the previous annotation is maintained in a probe annotation history (e.g., stored in the probe database 550) that is associated with the probe. This provides a way to track annotation changes of a probe over time, thereby providing additional functionality to the system and methods of the invention. Virtually any type of probe-specific information can be stored in the probe database.

In certain embodiments, the system and methods of the invention include determining a candidate target quality score for an associated annotation of a probe. In certain embodiments, candidate target quality score is based on the reliability of the sequence of the candidate target in the database. The reliability of a sequence (or database of sequences) can be affected by any number of factors, including that the sequence(s) is based on a single unverified submission (e.g., the sequence was only recently submitted to the database), that the sequence(s) contains numerous errors (e.g., as verified by other similar sequences in the database), that the sequence(s) is of poor quality (e.g., contains many unreadable nucleotides/amino acids), that the quality of sequence curation of the database is low (or non-existent), that the amount of annotation is low, etc. Candidate target quality scores may also be based on other factors, including empirical data for a particular probe (e.g., results of a binding assay for a candidate target and the probe), the relationship between the candidate targets that have been associated with a probe using the system/method of the invention (e.g., the similarity in calculated thermodynamic property of binding, organism of origin, gene family, etc.), and/or other probes to which a target is associated (e.g., if a target is associated with multiple probes in the probe database).

In certain embodiments, annotation of probes in the probe database is updated on a regular schedule (e.g., every day, week, month, etc.) thereby providing a continually-updated annotated probe database. Such a system will ensure that any changes in the sequences and/or annotations of targets in the target databases (either public or private) will be reflected in the annotations associated with the probes in the probe database.

Probes annotated according to the subject systems and methods find use in a variety of different applications, where such applications include, but are not limited to, analyte detection applications in which the presence of a particular analyte in a given sample is detected at least qualitatively, if not quantitatively. Analyte detection methods include, but are not limited to, northern blots, western blots, dot blots, southern blots, etc.

In certain embodiments, probes annotated using the subject system and methods are employed in a chemical array format. Any convenient method for carrying out assays employing a chemical array(s) may be used. In certain of such methods, the sample suspected of comprising the analyte of interest is contacted with an array of immobilized probes annotated according to the subject methods under conditions sufficient for the analyte to bind to the probe. Thus, if the analyte of interest is present in the sample, it binds to the array at the site of its cognate probe and a complex is formed on the array surface. The presence of this binding complex on the array surface is then detected, e.g. through use of a signal production system, e.g. an isotopic or fluorescent label present on the analyte, etc. The presence of the analyte in the sample is then deduced from the detection of binding complexes on the substrate surface.

Specific analyte detection applications of interest include hybridization assays in which the nucleic acid arrays of the subject invention are employed. In these assays, a sample of target nucleic acids is first prepared, where preparation may include labeling of the target nucleic acids with a label, e.g. a member of signal producing system. Following sample preparation, the sample is contacted with the array under hybridization conditions, whereby complexes are formed between target nucleic acids that are complementary to probe sequences attached to the array surface. The presence of hybridized complexes is then detected. Specific hybridization assays of interest which may be practiced using the subject arrays include: gene discovery assays, differential gene expression analysis assays; nucleic acid sequencing assays, and the like. Patents and patent applications describing methods of using arrays in various applications include: U.S. Pat. Nos. 5,143,854; 5,288,644; 5,324,633; 5,432,049; 5,470,710; 5,492,806; 5,503,980; 5,510,270; 5,525,464; 5,547,839; 5,580,732; 5,661,028; 5,800,992. Also of interest are U.S. Pat. Nos. 6,656,740; 6,613,893; 6,599,693; 6,589,739; 6,587,579; 6,420,180; 6,387,636; 6,309,875; 6,232,072; 6,221,653; and 6,180,351. In certain embodiments, the subject methods include a step of transmitting data from at least one of the detecting and deriving steps, as described above, to a remote location.

Where the arrays are arrays of polypeptide binding agents, e.g., protein arrays, specific applications of interest include analyte detection/proteomics applications, including those described in U.S. Pat. Nos. 4,591,570; 5,171,695; 5,436,170; 5,486,452; 5,532,128 and 6,197,599 as well as published PCT application Nos. WO 99/39210; WO 00/04832; WO 00/04389; WO 00/04390; WO 00/54046; WO 00/63701; WO 01/14425 and WO 01/40803—the disclosures of which are herein incorporated by reference.

As such, in using an array having probes annotated by the system and method of the present invention, the array will typically be exposed to a sample (for example, a fluorescently labeled analyte, e.g., protein containing sample) and the array then read. Reading of the array may be accomplished by illuminating the array and reading the location and intensity of resulting fluorescence at each feature of the array to detect any binding complexes on the surface of the array. For example, a scanner may be used for this purpose which is similar to the AGILENT MICROARRAY SCANNER available from Agilent Technologies, Palo Alto, Calif. Other suitable apparatus and methods are described in U.S. Pat. Nos. 5,091,652; 5,260,578; 5,296,700; 5,324,633; 5,585,639; 5,760,951; 5,763,870; 6,084,991; 6,222,664; 6,284,465; 6,371,370 6,320,196 and 6,355,934. However, arrays may be read by any other method or apparatus than the foregoing, with other reading methods including other optical techniques (for example, detecting chemiluminescent or electroluminescent labels) or electrical techniques (where each feature is provided with an electrode to detect hybridization at that feature in a manner disclosed in U.S. Pat. No. 6,221,583 and elsewhere). Results from the reading may be raw results (such as fluorescence intensity readings for each feature in one or more color channels) or may be processed results such as obtained by rejecting a reading for a feature which is below a predetermined threshold and/or forming conclusions based on the pattern read from the array (such as whether or not a particular target sequence may have been present in the sample or an organism from which a sample was obtained exhibits a particular condition). The results of the reading (processed or not) may be forwarded (such as by communication) to a remote location if desired, and received there for further use (such as further processing).

The probe annotation system and methods of the invention find use in a number of additional applications, some of which are described below.

The system and methods of the present invention find use in checking the quality of or revising hybridization data previously obtained for a probe or set of probes. For example, a user can submit sequences for the probe or probes used in a hybridization assay to a system of the invention to obtain updated annotation for the probe(s). In certain embodiments, the user can provide details of the hybridization assay so that the returned annotations are relevant to the experiment performed. For example, if the sample was derived from murine cells, the updated annotations (or the database searched) will be specific for mouse targets. In addition, the user may submit specifics regarding the hybridization or binding conditions under which the assay was performed (e.g., buffer composition, buffer pH, temperature of hybridization, duration of hybridization, concentration of probe and/or target, type of label on a probe and/or target molecule and type of hybridization assay, e.g., microarray, northern, PCR, FISH, etc.) which will be used in associating and ranking target annotations to the probe(s). For example, if a hybridization assay was performed under low stringency conditions, the system will associate and rank target annotations that have calculated thermodynamic binding properties at or above this level. Upon obtaining the updated annotations, the user can re-analyze and/or re-interpret the results of the experiment. This type of data re-analysis using the systems and methods of the invention allows a user to avoid mis-interpreting previously obtained data due to poor or inaccurate annotation caused by mistakes in a sequence database or due to annotations being associated with a probe that are not relevant given the specifics of the assay in which they were employed.

The system and methods of the invention find use in identifying optimal probes for a particular assay. For example, a user can provide specific parameters for a binding assay and query a database of probes annotated according to the methods of the invention to identify those that will function appropriately. For example, a user can provide the organism from which the sample is derived, specific genes of interest from the organism, the binding conditions of the experiment (e.g., buffer composition, buffer pH, temperature of hybridization, duration of hybridization, concentration of probe and/or target, type of label on a probe and/or target molecule and type of hybridization assay, e.g., microarray, northern, PCR, FISH, etc.), and/or a minimum threshold thermodynamic property of probe binding. The system will query the probe database and return probes that meet the input criteria (e.g., probes that will bind specifically to a target under the conditions provided). By employing this method, a user is prevented form using probes having outdated annotations that will hamper accurate data interpretation and analysis.

The system and methods of the invention also find use in applications for predicting the results of a specific probe/target binding assay. For example, a user can submit to the system the identity of a sample (e.g., tissue and organism form which the sample is derived), assay conditions, and probe sequences of interest. The system will annotate the probes according to the methods of the invention and return expected results of the binding assay, either qualitative or quantitative, based on the calculated thermodynamic properties between a probe and target and the assay parameters provided by the user. In certain embodiments, the system may flag probes that bind tightly to more than one target in the sample of interest so that a user may decide whether to exclude the probe in the assay. In certain embodiments, the system may provide binding assay conditions that will reduce cross-hybridization of targets in the indicated sample and the probes.

The invention also provides programming, e.g., in the form of computer program products, for use in practicing the probe annotation methods of the invention. Programming according to the present invention can be recorded on computer readable media, e.g., any medium that can be read and accessed directly by a computer. Such media include, but are not limited to: magnetic storage media, such as floppy discs, hard disc storage medium, and magnetic tape; optical storage media such as CD-ROM; electrical storage media such as RAM and ROM; and hybrids of these categories such as magnetic/optical storage media. Any convenient medium or storage method can be used to create a manufacture that includes a recording of the present programming/algorithms for carrying out the above described methodology.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

What is claimed is:

1. A system for annotating a probe, said system comprising:
(A) a communication module comprising an input manager for receiving input from a user and an output manager for communicating output to a user;
(B) a database comprising annotated sequence information; and
(C) a processing module comprising:
(i) a probe annotation manager, wherein said probe annotation manager is configured to:
(a) search said database to identify candidate targets for a probe, wherein said candidate targets comprise at least one region of similarity with a predetermined target sequence for said probe;
(b) calculate at least one thermodynamic property of binding of said probe to each of said candidate target sequences; and
(c) generate an annotation for said probe, wherein said annotation for said probe comprises annotations of said candidate targets that are ranked based upon said calculated thermodynamic property.

2. The system of claim 1, wherein said database comprises a public database.

3. The system of claim 2, wherein said public database is selected from: Ensembl, RefSeq, Tiger HGI, NCBI EST, NCBI Unigene, UCSC MRNA, and combinations thereof.

4. The system of claim 1, wherein said database comprises a private database.

5. The system of claim 1, further comprising a probe database.

6. The system of claim 5, wherein said probe database comprises annotated probe sequences.

7. The system of claim 5, wherein said probe annotation manager is configured to store said generated probe annotation in said probe database.

8. The system of claim 7, wherein said probe annotation manager is configured to maintain any previous probe annotation(s) for said probe in said probe database.

9. The system of claim 8, wherein said probe annotation manager is configured to annotate probes in said probe sequence database at defined intervals.

10. The system of claim 8, wherein said probe annotation manager annotates probes in said probe database when prompted by a user.

11. The system of claim 1, wherein said probe annotation manager annotates a probe sequence submitted by a user.

12. The system of claim 1, wherein said at least one thermodynamic property is selected from: ΔG, ΔH and Tₘ.

13. The system of claim 1, wherein said probe annotation manager is further configured to return annotation information to a user for at least one probe based on a minimum threshold value for a thermodynamic property of probe/target binding entered by said user.

14. The system of claim 1, wherein said probe annotation manager is further configured to generate said predetermined target sequence.

15. The system of claim 14, wherein said predetermined target sequence is complimentary or substantially complementary to said probe sequence.

16. The system of claim 1, wherein said probe annotation manager is further configured to return annotation information to a user for at least one probe based on at least one hybridization condition.

17. The system of claim 16, wherein said at least one hybridization condition is selected from: buffer composition, buffer pH, temperature of hybridization, duration of hybridization, concentration of probe and/or target, type of label on a probe or target molecule, type of hybridization assay, and any combination thereof.

18. A method of annotating a probe, said method comprising:
(a) searching a database comprising annotated sequences to identify candidate target sequences for a probe, wherein said candidate target sequences comprise at least one region of similarity with a predetermined target sequence for said probe;
(b) calculating at least one thermodynamic property of binding of said probe to each of said candidate target sequences; and
(c) generating an annotation for said probe, wherein said annotation for said probe comprises annotations of said candidate targets that are ranked based upon said calculated thermodynamic property.

19. The method of claim 18, wherein said at least one thermodynamic property is selected from: ΔG, ΔH and Tₘ.

20. The method of claim 18, wherein said database is a public database.

21. The method of claim 20, wherein said public database is selected from: Ensembl, RefSeq, Tiger HGI, NCBI EST, NCBI Unigene, UCSC MRNA, and combinations thereof.

22. The method of claim 18, wherein said database is a private database.

23. The method of claim 18, wherein said predetermined target sequence is complimentary or substantially complementary to said probe sequence.

24. The method of claim 18, wherein said method further comprises storing said generated at least one annotation for said probe in a probe database.

25. The method of claim 24, wherein said probe database comprises previous annotation(s) for said probe.

26. A method of revising the results of a hybridization assay, said method comprising:
(a) updating the annotation of at least one probe employed in a hybridization assay according to a method of claim 18; and
(b) revising the results of said hybridization assay based on said updating.

27. A computer program product comprising a computer readable storage medium having a computer program stored thereon, wherein said computer program, when loaded onto a computer, operates said computer to:
(a) search a database to identify candidate target sequences for a probe sequence, wherein said candidate target sequences comprise at least one region of similarity with a predetermined target sequence for said probe;
(b) calculate at least one thermodynamic property of binding of said probe to said optimal target sequence and each of said candidate target sequences; and
(c) generating an annotation for said probe, wherein said annotation for said probe comprises annotations of said candidate targets that are ranked based upon said calculated thermodynamic property.
